(19) United States
(12) Patent Application Publication
(10) Pub. No.: US 2018/0250541 A1
(43) Pub. Date: Sep. 6, 2018

(54) ENHANCED DRY CHEMICAL FIRE EXTINGUISHING COMPOSITION, APPARATUS, AND METHOD

(71) Applicant: Gerald Flood, Royal Oak, MI (US)

(72) Inventor: Gerald Flood, Royal Oak, MI (US)

(21) Appl. No.: 15/447,080

(22) Filed: Mar. 1, 2017

(51) Int. Cl. A62D 1/06; A62C 13/62; A62C 35/02; A62C 99/00

(52) U.S. Cl. CPC A62D 1/06; A62C 99/0045; A62C 35/023; A62C 13/62

(57) ABSTRACT

A composition and apparatus for dry chemical fire extinguishing material is disclosed. The composition has a dry chemical fire extinguishing agent mixed with substantially spherical microspheres. The apparatus has a container for retaining the composition and a delivery nozzle. Also in the container is a propellant to convey the composition from the container to the nozzle. A fire is contacted by the composition to extinguish the fire.

### I. FIELD OF THE INVENTION

This invention relates generally to fire extinguishers. More specifically, the invention relates to dry chemical fire extinguishers. Most specifically, the invention relates to dry chemical fire extinguishing compositions, apparatus incorporating the compositions, and methods for using the compositions.

### II. BACKGROUND

Dry chemical compositions are widely used in fire extinguishing apparatus. These compositions comprise a dry, solid, fire extinguishing material which is in pulverized form. In a typical dry chemical fire extinguisher, a propellant gas is employed to selectably deliver the composition.

Use of dry chemical fire extinguishing compositions in pressurized extinguishing systems began around 1913. Today, dry chemical fire extinguishing compositions typically use chemical bases such as sodium bicarbonate, potassium bicarbonate, potassium carbonate, monoammonium phosphate, and potassium chloride, among others. Dry chemical fire extinguishing compositions are ground to a powder with a particle distribution typically between 5-110 microns, with a median particle size of around 20-30 microns. Most dry chemical fire extinguishing compositions on the market contain some sort of additive to reduce caking, increase the flowablity of the composition, or to accomplish some other goal.

Dry chemical extinguishing agents have a number of advantages as compared to liquid agents and gaseous agents. Dry chemical agents are stable over a wide range of environmental conditions, generally low in cost, nontoxic and environmentally safe, as well as being effective against a variety of types of fires. However, the solid nature of the dry chemical agents creates a number of problems which limit their use. A stream of dry chemical extinguishing agent travels in a generally line of sight path; hence, intervening structures can create shadows which prevent access of the agent to a fire. As a result, systems which rely upon dry chemical agents generally require that a number of discrete delivery units be placed throughout the area to be protected. Also, the density of the dry chemical agents generally requires the use of a fairly high pressure and/or volume flow of propellant to deliver the agent, and this high pressure can, in some instances, serve to spread a fire. For example, the impact of propellant and/or agent onto a pool of burning liquid can cause splashing and consequent dispersal of flaming liquid. All of these factors have limited, or complicated, the use of dry chemical based fire extinguishing systems.

For the foregoing reasons, there is a need for a light weight dry fire extinguishing composition with enhanced flow characteristics.

### III. SUMMARY

The present disclosure is directed to a fire extinguishing composition, a system for extinguishing fires, and a method for extinguishing a fire. The fire extinguishing composition comprises a dry chemical fire extinguishing agent and substantially spherical microspheres. The fire extinguishing system comprises a container for retaining a fire extinguishing composition, a delivery nozzle, and a propellant. The fire extinguishing composition held within the container comprises a dry chemical fire extinguishing agent and substantially spherical microspheres. In order to discharge the composition, the delivery nozzles are in fluid communication with the container. Once operated, the propellant conveys the composition from the container to the nozzles. A method to extinguish a fire is also disclosed. This method comprises contacting a fire with a fire extinguishing composition comprising a dry chemical fire extinguishing agent and substantially spherical microspheres.

### IV. BRIEF DESCRIPTION OF THE DRAWINGS

FIG. 1 illustrates an embodiment of the invention as a hand held fire extinguishing system.

FIG. 2 illustrates a particle size distribution of microspheres. The horizontal axis of the graph is the particle size and the vertical axis is the relative quantity of particles.

FIG. 3 illustrates an embodiment of the invention as a fixed fire extinguishing system that may be found in a permanent structure or vehicle.

### V. DETAILED DESCRIPTION

A composition primarily used to extinguish fires, a system for extinguishing fires, and a method to extinguish a fire are disclosed. The composition is a mixture of dry chemical fire extinguishing agent 10, 50 and microspheres 11, 51. The composition can be employed in most commercially available fire extinguishing devices, for instance, in hand held fire extinguishers or systems employed within buildings or vehicles.

The dry chemical fire extinguishing agent 10, 50 employed may comprise any one of the dry chemical agents known in the art. Various commercially available dry agents have been readily incorporated into compositions in accord with the present disclosure. Some dry chemical agents which may be employed in different embodiments of the disclosed composition include: ammonium phosphate, ammonium sulfate, magnesium aluminum silicate, barium sulfate, sodium bicarbonate, potassium bicarbonate, and calcium carbonate, as well as mixtures of the foregoing. However, one of ordinary skill in the art could readily adapt other dry chemical agents for use in the present disclosure. Available sources of appropriate dry chemical fire extinguishing agent include Amerex and Badger Corporation, among others. The dry chemical fire extinguishing agent used in the disclosed composition may be a type BC or a type ABC dry chemical, or a Purple-K type composition. The specific gravity of the dry chemical fire extinguishing agent used in various embodiments is typically about 1.8-2.7, and in aerated conditions, about 0.7-0.9. Dry fire extinguishing agents used in various embodiments are typically a fine powder. In some embodiments, minor constitutes are included in the dry chemical fire extinguishing agent to improve shelf life and prevent caking, as fire extinguishing agents typically remain dormant for extended periods of time before use. Constituents may include, for example, mica, silica, pigment, and combinations therein.

The dry chemical fire extinguishing agent may also include perlite. Perlite is formed during volcanic occurrences being the result of hydration of rhyolitic obsidian, a rock resulting of a sudden chilling of molten lava. Perlite is different than other volcanic glass because when heated to a suitable point in its softening range, it expands from 4 to 20 times its original volume.

The softening point of perlite is about 1600-2100 degrees Fahrenheit. Perlite has a specific gravity of about 2.2-2.4, and in its expanded bulk form about 0.08-0.20. An appropriate source of perlite is Pennsylvania Perlite Corporation. Perlite is typically included in the dry chemical fire extinguishing agent when the agent is intended to be used to extinguish metal based fires, including lithium-ion battery fires. Perlite is predominantly composed of SiO₂ . As such, other sources of SiO₂ known to a person of ordinary skill in the art could be used in place of perlite.

The disclosed composition includes microspheres 11, 51. Microspheres are generally spherical and have a diameter less than about 200 microns. FIG. 2 depicts the particle size distribution of the microspheres in an embodiment. The horizontal axis in FIG. 2 represents particle diameter and the vertical axis represents the relative quantity of particles with the respective to the corresponding particle size. The origin is located where the axes meet. In one embodiment, microspheres have particle size distributions with median particle sizes from about 20 microns to about 60 microns. In one embodiment, the 10^{th} percentile 31 of the particle size distribution by volume is about 50% of the median particle size 32, the 90^{th} percentile 33 of the particle size distribution by volume is about 1.6-1.8 times larger than the median particle size, and the maximum effective particle size is about 2 times larger than the median particle size. In an alternate embodiment, all of the microspheres are the same size. The microspheres can be composed of a wide range of materials. Glass and ceramic are two preferred materials. One embodiment of glass microspheres has a true density typically around 0.6 g/cc, while an alternate embodiment of glass microspheres has a density as low as about 0.12 g/cc. Microspheres can be hollow, solid, or a combination of both. Embodiments using hollow microspheres have reduced weight as compared to similar embodiments that utilize solid microspheres. On a weight basis, the microspheres make up between 0.5% and 10% of the composition. Preferably, the composition is approximately 1-5% microspheres by weight. Hollow glass and ceramic microspheres are commercially available from the 3M Corporation, and its hollow glass bubbles are one example of microspheres that may be used in the disclosed composition.

The disclosed composition is formed by creating a homogenous mixture of the dry chemical fire extinguishing agent 10, 50 and the microspheres 11, 51. Each component is added to a common vessel according to the desired concentration of the final mixture. Each component can be quantified by one of several techniques, including measuring the weight or volume of the component prior to or during the addition into the common vessel. Weight can be measured using a suitable load cell either off-line, prior to the component being added to the common vessel, in-process, by measuring the change of weight before and after the component was added to the common vessel, or in-line, using a mass flow meter. Volume can be measured using a container with suitable graduations off-line, prior to the component being added to the common vessel, in-process, by measuring the change in volume before and after the component was added to the common vessel, or in-line, using a volumetric flow meter or totalizer. The volume added of each component is multiplied by its density to determine the weight of the component added to common vessel. The contents of the common vessel are then agitated to produce a homogenous mixture. The agitation can be provided in any way suitable to produce a homogenous mixture, and commonly is provided by either shaking, mixing by hand, or tumbling the common vessel containing the composition, or using a mixing blade coupled to a motor or other suitable torque producing device to blend the composition. A homogenous mixture is achieved when a representative sample of the common vessel contains the approximate concentration of each component that was added to the common vessel. In the alternative, an in-process mixer can create a homogenous mixture when each component flows simultaneously into the mixer at mass flow rates respective to the desired concentration. The common vessel can be the container used to house the composition for deployment in a fire fighting system.

Like most dry chemical fire extinguishing materials, the primary use of the composition is to combat fires. A fire can be extinguished by contacting it with a sufficient amount of the composition. Contact between the fire and the composition can be accomplished through a variety of methods. One method is to discharge the composition onto a fire by a fire extinguishing system. A fire extinguishing system is a system used to discharge fire extinguishing materials. For instance, a fire extinguishing system can be as simple as a household fire extinguisher or as complex as the systems used within multiple level buildings with hundreds of discharge nozzles.

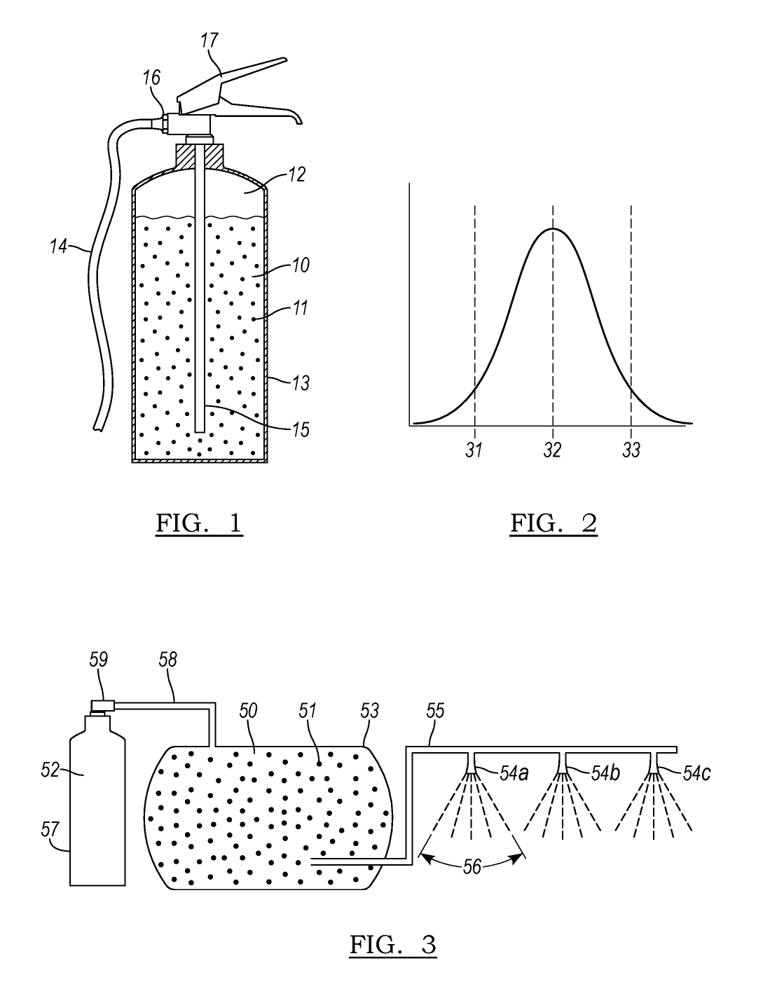

Fire extinguishing systems are commonly free standing devices, such as FIG. 1, or integrated into buildings or vehicles, shown in FIG. 3. These systems typically consist primarily of a container 13, 53, at least one delivery nozzle 16, 54a, 54b, 54c, and a propellant 12, 52. The container 13, 53 stores a dry fire extinguishing composition 10, 50, such as the disclosed composition, that is to be discharged when the system in FIG. 1 and FIG. 3 is activated. The container 13, 53 is of varying sizes, depending on the application. In an embodiment for handheld applications, containers may have a capacity of 1 liter. In an alternative embodiment, the container has a capacity of 74,000 liters. The composition is discharged by the delivery nozzles 16, 54a, 54b, 54c. The delivery nozzles 16, 54a, 54b, 54c, are connected to the container 13, 53 in a way that allows for the composition to travel from the container 13, 53 and out the delivery nozzles 16, 54a, 54b, 54c. For example, the delivery nozzles 16, 54a, 54b, 54c can be integral to the container 13 or connected to the container by a conduit 55. A dip tube 15 may be incorporated to ensure all contents of the container 13 are evacuated when the system is activated. The delivery nozzles 16, 54a, 54b, 54c assist with the direction of flow of the composition. Delivery nozzles 16, 54a, 54b, 54c can direct flow in a spray pattern with any distribution angle 56. Fixed delivery nozzles 54a, 54b, 54c typically have higher distribution angles, closer to 180 degrees, to maximize the contact area of the composition when discharged. Delivery nozzles 16 connected by flexible conduit 14 may have lower distribution angles, so users can discharge the composition locally to the fire to combat the fire using minimal composition. Some systems, such as a handheld extinguisher in FIG. 1, have one delivery nozzle 16 which is connected to a flexible conduit 14 that is aimed by the operator of the extinguisher. Other systems, like those in buildings and vehicles depicted in FIG. 3, may have a large number of delivery nozzles 54a, 54b, 54c depending on the size of the structure the system in FIG. 3 is employed in. These delivery nozzles 54a, 54b, 54c may be moveable or stationary. Propellant 12, 52 is used to force the composition from the container 13, 53 and out the delivery nozzles 16, 54a, 54b, 54c. This propellant 12, 52 is usually some form of pressurized gas, such as nitrogen or CO₂, and typically contained within the container 13 or stored in a vessel 57 separate from the container 53. Should the propellant 52 be stored in a vessel 57 separate from the container 53, the two must be connected in a way that allows the propellant to travel between the two 58. For example, in certain embodiments the propellant vessel and container are in fluid communication with one another by a propellant conduit 58. Once the system in FIG. 3 is actuated, propellant 52 is released from the vessel 57 into the container 53 forcing the composition from the container 53 and out the delivery nozzles 54a, 54b, 54c. Actuation of the system can be triggered manually by the operator of the system by a fluid control device 17. The fluid control device 17 could be a trigger, lever, push button, or other mechanism which the operator could use to actuate the system. The fluid control device 17 may be integral to the container 13, along the connection 58 between the vessel 57 and the container 53, as in 59, or any other place accessible to the operator of the system. The system can be actuated by other means as well, such as by sensors upon the detection of smoke.

The disclosed composition may be incorporated into a variety of fire extinguishing systems, including systems in which the extinguishing composition is dispersed from a single storage canister through a number of separate outlets in the protected area as well as self-contained systems including handheld extinguishers as well as structure-mounted units. A person of ordinary skill in the art would know what modifications are needed and how to adjust existing fire extinguishing systems for use with the disclosed composition.

Dry chemical fire extinguishing agents are also employed in a variety of applications including fire control and non-fire applications. For example, dry chemical fire extinguishing agents are employed to flameproof fabrics, paper, building materials and the like; they are also used in fertilizers, ceramics and other applications. Accordingly, the disclosed composition may also be used in these and other similar applications.

The present disclosure provides an improved dry chemical fire extinguishing composition, system and method. As will be explained below, it has been found that the presence of microspheres significantly enhances the delivery and performance of dry chemical fire extinguishing agent. The microspheres serve to better aerosolize the dry chemical agent, which facilitates its dispersal. As a result, the disclosed composition flows in a manner akin to a gas and more thoroughly envelopes the volume being protect. The enhanced flow and distribution qualities of the disclosed composition allow it to overcome the shadowing effects which have limited the use of other dry chemical fire extinguishing compositions. These qualities also make the disclosed composition more efficient, as smaller amounts of dry chemical extinguishing agent are needed to protect a given volume. As a result of this improved efficiency, fire extinguishing systems are able to operate at a reduced weight, as less fire extinguishing composition is required to protect the desired volume. This proves to be extremely beneficial, especially in fire extinguishing systems within vehicles were certain weight requirements must be met. Furthermore, due to its enhanced flow and distribution, lower pressures and/or lower volumes of propellant are needed to disperse the disclosed composition throughout a volume to be protected. The fluid-like flow characteristics of the disclosed composition also allow it to be used with relatively simple delivery nozzles of the type employed in liquid based extinguishing systems and eliminates the need for specialty delivery nozzles. However, the disclosed composition does not require all advantageous features and all advantages do not need to be incorporated into every embodiment of the disclosed composition.

One embodiment of the disclosed composition was prepared by mixing approximately 2% by weight of hollow borosilicate glass microspheres into monoammonium phosphate of the type commercially available from the Badger Corporation. This mixture was evaluated in various firefighting systems, and was found to be superior to, hollow microsphere-free, monoammonium phosphate compositions. Specifically, a series of Class B total flooding fire tests was performed per UL Standard 1254, Section 26.3 wherein four dry chemical fire extinguishers were placed in an 800 cubic food test cell measuring 10 feet by 10 feet with an 8 foot high ceiling. Two openings on opposite sides of the cell each represented 1% of the total surface area of the cell. An extinguisher which was charged with 9 pounds of the disclosed composition, pressurized with nitrogen to a pressure of approximately 175 pounds, and equipped with a flat, circular deflector nozzle, was mounted onto the center point of the ceiling. In subsequent tests, non-deflector, conventional nozzles were employed with similar results. For the Class B tests, twelve cans containing heptane were placed throughout the cell, one can at each of the four upper and four lower corners, and two cans by each opening. The heptane containers were ignited and allowed to burn for 30 seconds, after which the extinguisher was manually actuated. The extinguisher discharged the disclosed composition which quickly extinguished all of the fires. Similar results were found in connection with the extinguishing of Class A fires (UL 1254, 26.2).

A series of splash tests were carried out wherein a pan containing heptane and water filled to within 2 inches of its rim was ignited directly below the extinguisher. The extinguisher, which contained an embodiment of the disclosed composition, was discharged after 30 seconds and the cell was examined for evidence of splashing. In a number of separate tests, no evidence of splashing was found. The tests were carried out utilizing a series of different, commercially available delivery cylinders including Manchester cylinders and DDI cylinders. Performance for each was similar.

After the fire tests were carried out, the cylinder units were weighed and the amount of residual composition determined, and in every instance, it was found that the units successfully discharged over 97% of their composition. Inspection of the test cell revealed that the composition was very uniformly distributed therethrough, even on the uppermost surfaces of the extinguishing body. This dispersal is in contrast to that achieved using similar, microsphere-free, dry fire extinguishing agents.

In the foregoing tests it was found that 9 pounds of the composition could readily extinguish fires in an 800 cubic foot test volume. This represents a significant improvement in efficiency over microsphere-free dry fire extinguishing agents, which are documented to require 25 pounds of dry fire extinguishing agent to extinguish fires in a 1000 cubic foot test volume, and 17 pounds of dry fire extinguishing agent to extinguish fires in a 700 cubic foot test volume. Furthermore, the disclosed composition can function with a delivery system pressure of 175 psi of nitrogen, while microsphere-free dry chemical systems typically employ an 800 psi carbon dioxide cartridge for pressurizing the delivery.

The foregoing discussion and description is illustrative of particular embodiments of the present invention and is not meant to be a limitation upon the practice thereof. Yet other modifications and variations will be readily apparent to those of skill in the art in view of the teaching presented herein. It is the following claims, including all equivalents, which define the scope of the invention.

I claim:

1. A fire extinguishing composition comprising:
a dry chemical fire extinguishing agent; and
substantially spherical microspheres.

2. The composition of claim 1, wherein the microspheres are hollow.

3. The composition of claim 1, wherein the microspheres are glass spheres.

4. The composition of claim 1, wherein the microspheres are ceramic spheres.

5. The composition of claim 1, wherein the microspheres have a diameter in the range of about 10-170 microns.

6. The composition of claim 1, wherein the microspheres have a diameter in the range of about 20-60 microns.

7. The composition of claim 1, wherein the dry chemical fire extinguishing agent comprises a component selected from a group consisting of: ammonium phosphate, ammonium sulfate, magnesium aluminum silicate, barium sulfate, sodium bicarbonate, potassium bicarbonate, calcium carbonate, perlite, and combinations thereof.

8. The composition of claim 1, wherein the microspheres comprise, on a weight basis, about 0.5-10% of the composition.

9. The composition of claim 1, wherein the microspheres comprise, on a weight basis, about 1-5% of the composition.

10. A fire extinguishing system comprising:
a fire extinguishing composition, said composition comprising a mixture of a dry chemical fire extinguishing agent and substantially spherical microspheres;
a container for retaining the composition;
a delivery nozzle in fluid communication with the container; and
a propellant disposed and operable to convey the composition from the container to the nozzle.

11. The system of claim 10, wherein the microspheres are hollow.

12. The system of claim 10, further comprising a plurality of nozzles wherein each nozzle of the plurality of nozzles is in fluid communication with the container.

13. The system of claim 10, wherein the delivery nozzle is integral with the container.

14. The system of claim 10, wherein the delivery nozzle is in fluid communication with the container by a conduit.

15. The system of claim 10, wherein the propellant is disposed within the container.

16. The system of claim 10, wherein the propellant is disposed in a vessel which is separate from the container, the vessel being in fluid communication with the container by a propellant conduit.

17. The system of claim 16, wherein the propellant conduit includes a fluid control device which is selectably operable to initiate and terminate flow of propellant from the vessel to the container.

18. The system of claim 10, wherein the dry chemical fire extinguishing agent includes a component selected from the group consisting of: ammonium phosphate, ammonium sulfate, magnesium aluminum silicate, barium sulfate, sodium bicarbonate, potassium bicarbonate, calcium carbonate, perlite, and combinations thereof.

19. The system of claim 10, wherein the microspheres comprise hollow glass microspheres having a diameter in the range of about 10-170 microns.

20. A method of extinguishing a fire comprising, contacting the fire with a fire extinguishing composition comprising a mixture of a dry chemical fire extinguishing agent and substantially spherical microspheres.
